(19) United States
(12) Patent Application Publication
(10) Pub. No.: US 2025/0192815 A1
(43) Pub. Date: Jun. 12, 2025

(54) ELECTRONIC DEVICE PROTECTIVE CASE

(71) Applicant: GWD(Zhuhai) Intelligence Technology Ltd., Co., Zhuhai (CN)

(72) Inventors: Chao Wang, Zhuhai (CN); Guojin Lin, Zhuhai (CN); Xueqing Tan, Zhuhai (CN)

(73) Assignee: GWD(Zhuhai) Intelligence Technology Ltd., Co., Zhuhai (CN)

(21) Appl. No.: 18/975,466

(22) Filed: Dec. 10, 2024

(30) Foreign Application Priority Data
Dec. 11, 2023 (CN) 2023233716905
Jul. 31, 2024 (CN) 2024218486225

(51) Int. Cl. H04B 1/3888; H04M 1/02

(52) U.S. Cl. CPC H04B 1/3888; H04M 1/0274

(57) ABSTRACT

An electronic device protective case comprising a protective case body, a storage component, and a transmission component. The protective case body is a semi-enclosed structure for accommodating an external electronic device. An installation slot is arranged inside the protective case body. The storage component is arranged in the installation slot. The storage component includes a circuit board and a memory connected to the circuit board. A touch panel is arranged on the protective case body, and the touch panel is signally connected to the circuit board. The transmission component comprises a data cable, and a cable groove is also arranged inside the protective case body. The data cable is arranged in the cable groove, one end thereof is connected to the circuit board, and the other end of the data cable is connectable to the electronic device.

### RELATED APPLICATIONS

This application claims priority to China Patent Application Nos. 2023233716905, filed on Dec. 11, 2023, and 2024218486225, filed on Jul. 31, 2024. The content of both China patent applications is expressly incorporated herein in their entirety.

### TECHNICAL FIELD

The present application relates to the technical field of electronic equipment accessories, in particular to an electronic device protective case.

### BACKGROUND ART

An electronic device protective case is an electronic device accessory that can be mounted on an electronic device to protect it from being damaged by bumps or falls. In daily life, whether it is a mobile phone, tablet or other electronic device, a protective case is often used for protection. Electronic device protective cases are one of the most used and most common electronic device accessories.

However, even though such a protective case is frequently used and closely associated with electronic devices, there is currently insufficient innovative research on it. Existing protective cases for electronic devices typically serve only the purpose of physical protection and lack additional functional expandability. As a result, the advantage of their close association with electronic devices is underutilized.

Based on this, there is an urgent need to propose a solution to address the issues present in the existing technology.

### SUMMARY OF THE PRESENT INVENTION

To overcome the deficiencies of the existing technology, the present application provides a protective case for electronic devices that can expand storage space and functional buttons for the devices. It offers excellent functionality and practicality. The specific technical solutions are provided as follows:

The present application provides an electronic device protection case, comprising: a protection case body, a storage component, and a transmission component;
the protective case body is a semi-enclosed structure for accommodating an external electronic device;
an installation slot is arranged inside the protective case body, and the storage component is arranged in the installation slot, the storage component comprises a circuit board and a memory, and the memory is connected to the circuit board, a touch panel is arranged on the protective case body, and the touch panel is signal connected to the circuit board; and
the transmission component comprises a data cable, and a cable groove is further arranged inside the protective case body, one end of the cable groove is connected to the installation slot, and the other end thereof is connected to the outside world; the data cable is arranged in the cable groove, one end thereof is connected to the circuit board, and the other end of the data cable is used to connect the electronic device accommodated in the protective case body.

In a specific exemplary embodiment, the transmission component further comprises a connector for connecting to a charging port of the electronic device, and the connector is movably arranged at a bottom part of the protective case body; the end of the data cable away from the circuit board is connected to the connector, so as to achieve connection with the electronic device via the connector.

In a specific exemplary embodiment, the protective case body comprises a panel and a side baffle arranged along an edge of the panel;
the installation slot and the cable groove are both arranged inside the panel, and the touch panel is arranged on the panel; a movable seat is arranged at a bottom part of the side baffle, and the connector is arranged on the movable seat; a recessive slot adapted to the movable seat is provided at the bottom part of the side baffle, and the movable seat is used to drive the connector to connect the electronic device accommodated in the protective case body by being embedded in the recessive slot.

In a specific exemplary embodiment, the panel comprises a first panel and a second panel, an outer edge of the first panel is snap-connected to the side baffle, an inner edge of the first panel is provided with a boss, the second panel is attached to the boss, and a gap is arranged between the second panel and the first panel;
the installation slot and the cable groove are both arranged on a side of the first panel facing the second panel, and the touch panel is arranged on a side of the first panel facing away from the second panel.

In a specific exemplary embodiment, the first panel protrudes in a direction away from the second panel to form the installation slot; a protruding height of the first panel is between 0.5 mm and 5 mm.

In a specific exemplary embodiment, the circuit board is provided with a memory interface, and the circuit board is used to connect the memory via the memory interface; the protective case body is provided with a slot hole in communication with the installation slot, and the slot hole corresponds to the memory interface.

In a specific exemplary embodiment, the protective case body is detachably provided with a shielding member for shielding the slot hole.

In a specific exemplary embodiment, the connector comprises any one of a Type-C connector, a Micro-USB connector, and a Lightning connector.

In a specific exemplary embodiment, the protective case body is provided with a camera hole for allowing a camera of the external electronic device to pass therethrough.

In a specific exemplary embodiment, the camera hole and the installation slot are both arranged in an upper part of the protective case body.

The present application has at least the following beneficial effects:

Regarding the electronic device protective case provided by the present application, it achieves the functionality of expanding storage space for the device by means of providing the storage component and the transmission components. By providing a touch panel on the protective case body, it also enables an external touch function for the electronic device, offering excellent functionality and practicality. This addresses the issue of traditional protective cases having limited functionality. In terms of structure, by means of providing the installation slot and the cable groove, the present application ensures a compact and organized internal layout of the protective case body, enhancing external aesthetics and improving user experience. In addition, the storage component can adopt a detachable design, which, combined with the slot hole, facilitates the removal, replacement, and maintenance of the storage component, offering superior flexibility.

### BRIEF DESCRIPTION OF THE DRAWINGS

In order to more clearly illustrate the technical solutions in the embodiments of the present application, the following will briefly introduce the drawings required for the description of the embodiments. Obviously, the drawings described below are only some embodiments of the present application. For a person of ordinary skill in the art, other drawings can also be obtained based on these drawings without creative efforts.

FIG. 1 is a front view schematic diagram of the overall structure of the present application.

FIG. 2 is a rear view perspective schematic diagram of the overall structure of the present application.

FIG. 3 is a schematic cross-sectional view of A-A in FIG. 1.

FIG. 4 is a schematic diagram of the overall structure of the present application from one viewing angle.

FIG. 5 is a detailed schematic diagram of the movable seat of the present application.

FIG. 6 is an exploded schematic diagram of the overall structure of the present application from one viewing angle.

FIG. 7 is an exploded schematic diagram of the overall structure of the present application from another viewing angle.

Element symbols shown in the drawings:
1—protective case body; 11—panel; 111—first panel; 112—second panel; 12—side baffle; 121—recessive slot; 2—storage component; 21—circuit board; 22—memory; 3—transmission component; 31—data cable; 32—connector; 4—installation slot; 5—cable groove; 6—touch panel; 7—movable seat; 8—boss; 9—memory interface; 10—slot hole; 13—shielding member; 131—boss rod; 14—rod slot; 15—camera hole; 16—cover plate.

### DESCRIPTION OF THE EMBODIMENTS

In the following, various embodiments of the present application will be described more fully. The present application may have various embodiments, and adjustments and changes may be made therein. However, it should be understood that there is no intention to limit the various embodiments of the present application to the specific embodiments disclosed herein, rather the present application should be understood to cover all adjustments, equivalents and/or alternatives that fall within the principles and scope of the various embodiments of the present application.

In the following, the terms “comprise” or “can comprise” used in various embodiments of the present application indicate the presence of disclosed functions, operations or elements, and do not limit the addition of one or more functions, operations or elements. In addition, as used in various embodiments of the present application, the terms “comprise”, “have” and the equivalents are intended only to indicate specific features, numbers, steps, operations, elements, components or combinations of the foregoing items, and should not be understood as first excluding the presence of one or more other features, numbers, steps, operations, elements, components or combinations of the foregoing items or the possibility of adding one or more features, numbers, steps, operations, elements, components or combinations of the foregoing items.

In various embodiments of the present application, the expression “or” or “at least one of A or/and B” includes any or all combinations of the words listed at the same time. For example, the expression “A or B” or “at least one of A or/and B” may include A, may include B, or may include both A and B.

The expressions used in various embodiments of the present application (such as “first”, “second”, etc.) may modify various constituent elements in various embodiments, but may not limit the corresponding constituent elements. For example, the above expressions do not limit the order and/or importance of the elements. The above expressions are only used for the purpose of distinguishing one element from other elements. For example, the first user device and the second user device indicate different user devices, although both are user devices. For example, without departing from the scope of various embodiments of the present application, the first element may be referred to as the second element, and similarly, the second element may also be referred to as the first element.

It should be noted that in the present application, unless otherwise explicitly specified and defined, the terms such as “mounting”, “connection”, “fixation” and the like should be understood in a broad sense. For example, it can be a fixed connection, a detachable connection, or an integral connection; it can be a mechanical connection or an electrical connection; it can be a direct connection or an indirect connection via an intermediate medium; it can be an internal communication between two components. For a person of ordinary skill in the art, the specific meanings of the above terms in the present application can be understood according to the specific circumstances.

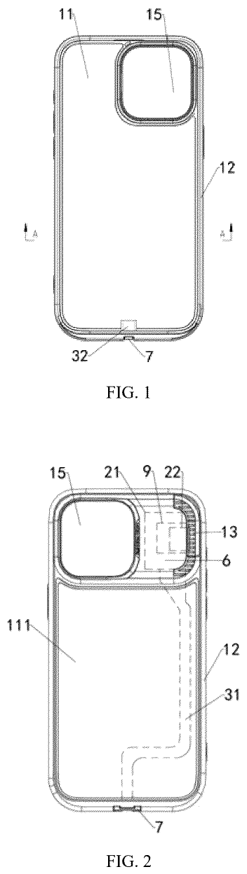

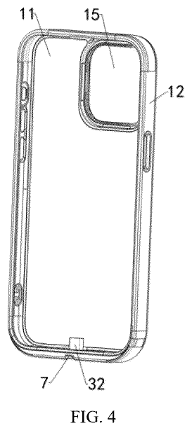

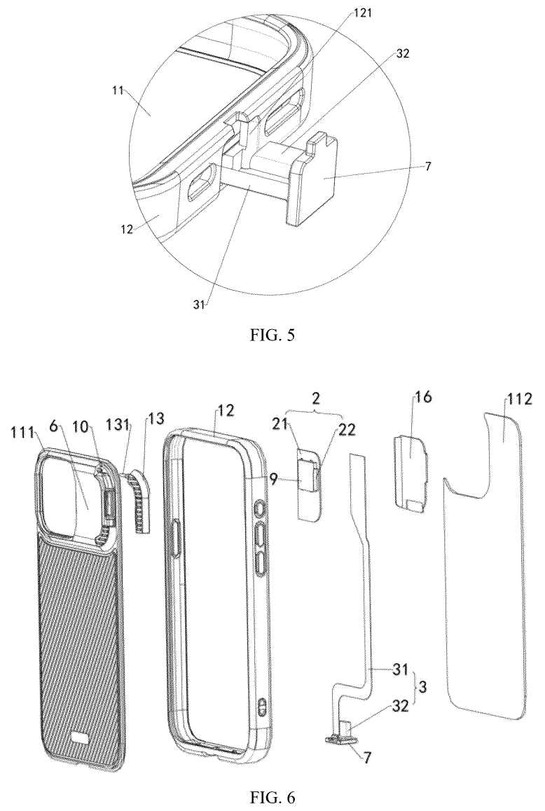

With reference to FIG. 1 to FIG. 7, the present application provides an electronic device protective case, which includes: a protective case body 1, a storage component 2 and a transmission component 3.

Specifically, the protective case body 1 is a semi-enclosed structure for accommodating an external electronic device. For example, the electronic device can be a smart terminal device such as a mobile phone or a tablet computer. The present application does not specifically limit the size and material of the protective case body 1, and its size and material can be adaptively selected according to the specifications of the electronic device.

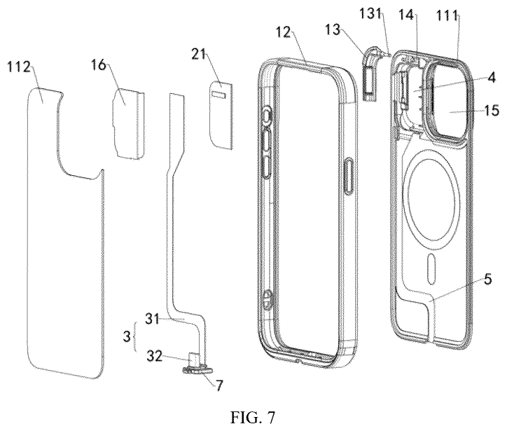

With reference to FIG. 2, FIG. 6 and FIG. 7, the protective case body 1 is provided with an installation slot 4, and the storage component 2 is provided in the installation slot 4. Optionally, the storage component 2 can be fixedly provided in the installation slot 4, or can be detachably provided in the installation slot 4. Preferably, the storage component 2 is detachably provided in the installation slot 4, so as to facilitate the disassembly, maintenance and replacement of the storage component 2. After the storage component 2 is provided in the installation slot 4, it can also be covered by a cover plate 16 to achieve further security. Specifically, the storage component 2 includes a circuit board 21 and a memory 22, and the memory 22 is connected to the circuit board 21. A touch panel 6 is provided on the protective case body 1, and the touch panel 6 is signal connected to the circuit board 21. Optionally, the touch panel 6 includes but is not limited to a capacitive touch panel, a resistive touch panel, or the like. Optionally, the circuit board 21 includes but is not limited to a USB adapter board, a SATA adapter board, a PCIe expansion board, or the like. Optionally, the memory 22 includes but is not limited to a storage medium, such as an external memory card, a mobile hard disk, or the like.

The transmission component 3 includes a data cable 31, and a cable groove 5 is also provided inside the protective case body 1. One end of the cable groove 5 is connected to the installation slot 4, and the other end thereof is connected to the outside. The data cable 31 is arranged in the cable groove 5, one end thereof is connected to the circuit board 21, and the other end of the data cable 31 is used to connect the electronic device accommodated in the protective case body 1 by extending to the outside. The cable groove 5 can accommodate the data cable 31 and guide the direction of the data cable 31, making the interior of the protective case body 1 more organized and compact.

In a specific embodiment, the transmission component 3 may also include a connector 32, and the connector 32 is movably arranged at the bottom part of the protective case body 1 for connecting the electronic device contained in the protective case body 1. For example, one end of the cable groove 5 extends to the bottom part of the protective case body 1 near the connector 32 and is connected to the outside world, so that the end of the data cable 31 away from the circuit board 21 can extend out of the protective case body 1 and connect to the connector 32. For example, the connector 32 can be connected to the electronic device by inserting it into a charging port of the electronic device. Optionally, the connector 32 includes but is not limited to any one of a Type-C connector, a Micro-USB connector and a Lightning connector, which can be adaptively provided according to actual conditions and is not specifically limited herein.

It can be understood that in this embodiment, the memory 22 and the touch panel 6 in the protective case body 1 can eventually be connected to the external electronic device via the circuit board 21, the data cable 31 and the connector 32. The memory 22 is connected to the electronic device to realize data interaction with the electronic device, thereby expanding the storage space for the electronic device. The touch panel 6 is connected to the electronic device, which can expand the control mode of external touch for the electronic device. The specific function of the touch panel 6 can be defined in the software of the electronic device. For example, the function of the touch panel 6 can be defined as being used to cut off the connection between the memory 22 and the electronic device. In addition, in terms of structure, the memory 22, the circuit board 21 and the data cable 31 of the present application are all arranged in the protective case body 1, and are arranged by the installation slot 4 and the cable groove 5. While maintaining a compact and organized structure, it also provides excellent installation stability.

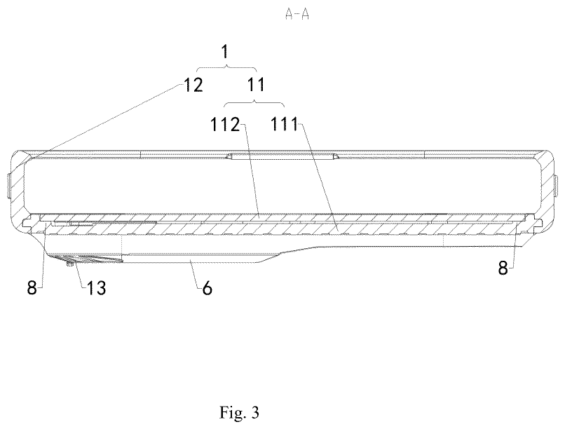

In a specific embodiment, with reference to FIG. 3 to FIG. 7, the protective case body 1 may include a panel 11, and a side baffle 12 arranged along an edge of the panel 11. The installation slot 4 and the cable groove 5 are both arranged inside the panel 11; the storage component 2 is arranged in the installation slot 4, and the data cable 31 is arranged in the cable groove 5; as a result, both of them are also arranged inside the panel 11, while the touch panel 6 is arranged on the panel 11.

A movable seat 7 is provided at the bottom part of the side baffle 12, and the connector 32 is provided on the movable seat 7. A recessive slot 121 adapted to the movable seat 7 is provided at the bottom part of the side baffle 12. The movable seat 7 is used to drive the connector 32 to connect the electronic device accommodated in the protective case body 1 by being embedded in the recessive slot 121. It can be understood that in practical applications, when the electronic device is accommodated in the protective case body 1, the charging port of the electronic device corresponds to the recessive slot 121, and the movable seat 7 is embedded in the recessive slot 121, so that the connector 32 thereon can be inserted into the charging port of the electronic device, thereby realizing the connection between the connector 32 and the electronic device. Optionally, the movable seat 7 can be rotated relative to the side baffle 12, or can be translated relative to the side baffle 12 in one direction, which is not specifically limited herein. Regardless of the specific movable mode adopted, it is ultimately necessary to enable the movable seat 7 to be embedded in the recessive slot 121 so that the connector 32 is connected to the charging port of the electronic device.

Furthermore, with reference to FIGS. 3, 6, and 7, the panel 11 may include a first panel 111 and a second panel 112. An outer edge of the first panel 111 is protruded, and a side wall of the side baffle 12 is recessed. Thus, the outer edge of the first panel 111 can be snap-connected to the side baffle 12 by means of the cooperation between the protrusion and the recession. An inner edge of the first panel 111 is provided with a boss 8, the second panel 112 is attached to the boss 8, and there is a gap between the second panel 112 and the first panel 111. The gap herein can provide additional room for the movement of the data cable 31, ensuring that when the connector 32 moves, the data cable 31 can better follow. The installation slot 4 and the cable groove 5 are both arranged on the side of the first panel 111 facing the second panel 112. The touch panel 6 is arranged on the side of the first panel 111 away from the second panel 112.

Exemplarily, the first panel 111 is used for direct contact with the electronic device, so a silicone panel, a TPU panel, a PC panel or an ABS panel can be used. The second panel 112 is used to collide with external objects when falling, so a metal panel or other material panel with good impact resistance can be used.

Furthermore, the first panel 111 is protruded in a direction away from the second panel 112 so as to form the installation slot 4. The protruding height of the first panel 111 ranges from 0.5 mm to 5 mm. In practical applications, the protruding height of the first panel 111 can be reasonably designed according to the space requirements of the installation slot 4 and the aesthetic needs of the overall appearance.

In a specific embodiment, with reference to FIG. 2 and FIG. 6, a memory interface 9 is provided on the circuit board 21, and the circuit board 21 is configured to connect the memory 22 via the memory interface 9. For example, the memory 22 may be a TF card or an SD card, the memory interface 9 may be a card slot adapted for the memory 22, and the memory 22 is connected to the circuit board 21 by means of being inserted into the memory interface 9. A slot hole 10 connected to the installation slot 4 is further provided on the protective case body 1, and the slot hole 10 corresponds to the memory interface 9, so that the memory 22 can be inserted into the memory interface 9 through the slot hole 10.

Furthermore, the protective case body 1 is further detachably provided with a shielding member 13 for shielding the slot hole 10, so that the slot hole 10 can be shielded after the memory 22 is inserted to prevent dust and other debris from entering. For example, a boss rod 131 can be provided on the shielding member 13, and a rod slot 14 adapted to the boss rod 131 is further provided on the protective case body 1. The shielding member 13 is detachably embedded in the rod slot 14 with the boss rod 131, so that the slot hole 10 can be finally covered to achieve the shielding effect of the slot hole 10.

In a specific embodiment, the protective case body 1 is further provided with a camera hole 15 for the camera of an external electronic device to pass therethrough. Common electronic devices generally have slightly protruding cameras. Thus the camera hole 15 is adapted to the camera, and its edge also has a certain height.

Preferably, the camera hole 15 and the installation slot 4 are both located in the upper part of the protective case body 1. In the embodiment where the first panel 111 is protruded to form the installation slot 4, the protruding height of the first panel 111 is preferably the same as the height of the edge of the camera hole 15.

In summary, the application provides an electronic device protective case; the protective case achieves the functionality of expanding storage space by means of providing the storage component 2 and the transmission component 3. In addition, by further providing the touch panel 6 on the protective case body 1, it also enables an external touch interface for the electronic device, providing excellent functionality and practicality, and addressing the issue of traditional protective cases having limited functionality. In terms of structure, by means of providing the installation slot 4 and the cable slot 5, it ensures a compact and organized interior for the protective case body 1, while enhancing its external aesthetics and improving the user experience. Moreover, the storage component 2 is designed to be detachable. Combined with the slot hole 10, this facilitates easy removal, replacement, and maintenance of the storage component 2, thereby offering great flexibility.

A person skilled in the art can understand that the accompanying drawings are only schematic diagrams of a preferred implementation scenario, and the modules or processes shown in the accompanying drawings are not necessarily required for implementing the present application.

A person skilled in the art can understand that the modules in the device in an implementation scenario can be distributed in the device of the implementation scenario according to the description of the implementation scenario, or can be changed accordingly and located in one or more devices different from the implementation scenario. The modules of the above implementation scenario can be combined into one module, or further divided into multiple sub-modules.

The element numerals used in the present application are only for the purpose of description and do not represent the advantages or disadvantages of the implementation scenarios.

The above description is merely for some preferred embodiments of the present application, and is not intended to limit the present application. Any modification, equivalent replacement, improvement, and the like made within the spirit and principle of the present application shall be included in the scope of protection of the present application.

We claim:

1. An electronic device protective case comprising: a protective case body, a storage component, and a transmission component; wherein:
the protective case body is a semi-enclosed structure for accommodating an external electronic device;
an installation slot is arranged inside the protective case body, and the storage component is arranged in the installation slot, the storage component comprises a circuit board and a memory, and the memory is connected to the circuit board, a touch panel is arranged on the protective case body, and the touch panel is signally connected to the circuit board; and
the transmission component comprises a data cable, and a cable groove is further arranged inside the protective case body, one end of the cable groove is connected to the installation slot, and the other end thereof is connected to the outside; the data cable is arranged in the cable groove, one end thereof is connected to the circuit board, and the other end of the data cable is used to connect the electronic device accommodated in the protective case body.

2. The electronic device protective case according to claim 1 wherein the transmission component further comprises a connector for connecting to a charging port of the electronic device, and the connector is movably arranged at a bottom part of the protective case body; the end of the data cable away from the circuit board is connected to the connector, so as to achieve connection with the electronic device via the connector.

3. The electronic device protective case according to claim 2, wherein the protective case body comprises a panel and a side baffle arranged along an edge of the panel;
the installation slot and the cable groove are both arranged inside the panel, and the touch panel is arranged on the panel; a movable seat is arranged at a bottom part of the side baffle, and the connector is arranged on the movable seat; a recessive slot adapted to the movable seat is provided at the bottom part of the side baffle, and the movable seat is used to drive the connector to connect the electronic device accommodated in the protective case body by being embedded in the recessive slot.

4. The electronic device protective case according to claim 3, wherein the panel comprises a first panel and a second panel, an outer edge of the first panel is snap-connected to the side baffle, an inner edge of the first panel is provided with a boss, the second panel is attached to the boss, and a gap is arranged between the second panel and the first panel;
the installation slot and the cable groove are both arranged on a side of the first panel facing the second panel, and the touch panel is arranged on a side of the first panel facing away from the second panel.

5. The electronic device protective case according to claim 4, wherein the first panel protrudes in a direction away from the second panel to form the installation slot; a protruding height of the first panel is between 0.5 mm and 5 mm.

6. The electronic device protective case according to claim 1, wherein the circuit board is provided with a memory interface, and the circuit board is used to connect the memory via the memory interface; the protective case body is provided with a slot hole in communication with the installation slot, and the slot hole corresponds to the memory interface.

7. The electronic device protective case according to claim 6, wherein the protective case body is detachably provided with a shielding member for shielding the slot hole.

8. The electronic device protective case according to claim 2, wherein the connector comprises any one of a Type-C connector, a Micro-USB connector, and a Lightning connector.

9. The electronic device protective case according to claim 1, wherein the protective case body is provided with a camera hole for allowing a camera of the external electronic device to pass therethrough.

10. The electronic device protective case according to claim 9, wherein the camera hole and the installation slot are both arranged in an upper part of the protective case body.
